(19) United States
(12) Patent Application Publication
(10) Pub. No.: US 2017/0056892 A1
(43) Pub. Date: Mar. 2, 2017

(54) CENTRIFUGE DRUM

(71) Applicant: Ferrum AG, Rupperswil (CH)

(72) Inventors: Scalzo GIUSEPPE, Rupperswil (CH); Tschabold TOBIAS, Pratteln (CH); Kostrewa EMIL, Moriken (CH)

(21) Appl. No.: 15/235,614

(22) Filed: Aug. 12, 2016

(30) Foreign Application Priority Data
Aug. 26, 2015 (EP) 15182585.8

(51) Int. Cl. B04B 7/18; B01D 33/06

(52) U.S. Cl. CPC B04B 7/18; B01D 33/06

(57) ABSTRACT

A centrifuge drum includes a drum lid, a drum base and a drum jacket. The drum jacket has discharge holes arranged in radial direction to a longitudinal axis. The drum lid and the drum base are arranged perpendicularly to the longitudinal axis diametrically opposite the drum jacket and the drum lid. The drum base and the drum jacket enclose an inner space of the centrifuge drum. The centrifuge drum, in the installed state, is rotatable in the centrifuge around the longitudinal axis, and in the operating state is rotatable around the longitudinal axis by a drive with a predeterminable rotational speed. A filter medium is disposed at an inner peripheral surface of the drum jacket, the filter medium being fixed by a fixing arrangement to the inner peripheral surface of the drum jacket. The fixing arrangement includes a fixing socket extending along a socket axis, with a fixing collar.

### CROSS-REFERENCE TO RELATED APPLICATIONS

This application claims benefit to EP 15182585.8, filed Aug. 26, 2015, the contents of which is hereby incorporated herein by reference.

### BACKGROUND

Field of the Invention

The invention relates to a centrifuge drum.

Background of the Invention

For drying damp substances or damp substance mixtures, many different kinds of centrifuges are widely used and are employed for very diverse applications. For example, for drying high-purity pharmaceutical products, discontinuously working centrifuges such as peeler centrifuges, are preferably used, in which after dividing a mixture into a solid material cake and a liquid phase, the solid material cake is peeled off the drum wall with a peeler device and discharged from the drum via suitable means such as a chute. With other discontinuous systems, preferably not only with centrifuges of laboratory scale, it can be that no automatic peeling arrangement is provided, but that the centrifuge is stopped after the mixture is divided, and the deposited solid material cake is manually removed from the drum.

In particular when continuously large quantities of a solid/liquid mixture are to be divided, continuously operating pusher centrifuges are used to advantage. Depending on requirements, single-stage, multiple-stage as well as so-called two-stage pusher centrifuges are used.

Persons skilled in the art have long been well aware of these centrifuge types, which have been described in detail, for example, in the standard work by Professor W. Stahl, “Industrie-Zentrifugen” (Industrial centrifuges), published by DrM PRESS.

### SUMMARY

As a rule, the centrifuge drum itself is designed as a hollow cylinder which has a large number of discharge holes in its peripheral surface through which the liquid phase to be centrifuged off is conducted outside. It means that the drum of filter centrifuges has holes arranged in regular patterns, e.g. spaced a few centimetres apart, to discharge the filtrate, i.e. the liquid phase, through the drum jacket.

The inner peripheral surface of the centrifuge drum is then often lined with an additional filter medium such as a filter cloth on which the solid cake is sedimented off during the centrifugation process.

Due to its barrier effect against the flow of the solids in the suspension, the filter medium initiates cake formation. Special care must be taken to secure the filter medium against possible peripheral displacement since, for example, tangential acceleration or cutting forces could occur in the filling process or during peeling, and axial distortion, too, must be prevented to ensure that the filter cloth is secured against displacement along the rotational axis of the centrifuge drum.

Several methods for ensuring this are known in prior art, which are also listed and described in the above cited book by Professor Stahl.

For example, in peeler centrifuges, the filter cloth is placed on the supporting cloth in continuous lengths and in two overlapping pieces each at half the circumference, such that the inflowing suspension cannot run between the two cloth halves, i.e. the upper cloth lies against the running direction.

A main disadvantage of that solution is that the overlapping doubles the filter cloth resistance, which means that the thickness of the cake can be reduced at these overlapping parts. As well, dehumidification is less effective in these areas. Furthermore, the overlapping must be symmetrical to prevent the formation of an imbalance at the joint.

A considerable improvement in comparison with the overlapping cloths are endless filter cloths in cylinder form which provide a certain comfort, i.e. in particular a simplification in terms of insertion and removal. Moreover, they considerably mitigate the problems of overlapping filter cloths, especially in case of critical filtration applications.

So far, such cylindrical filter cloths, but also open filter cloths have been fixed at both ends of the drum, in a groove or channel that is cut around the drum jacket in peripheral direction after the drum is manufactured.

The filter medium, i.e. for example the filter cloth, is beaten into the said peripheral dovetailed grooves or channels near the front or back of the centrifuge drum, and the free overhang of the filter cloth is then simply cut off. The filter cloth is tightly inserted into the groove or channel by pounding in, for example, a string of fine nickel chrome steel wires or a round rubber cord with a full circular cross-section.

This type of fastening is unsatisfactory for various reasons. The dovetailed channel at the transition points to the front annular disc or the rear full disc of the drum is an extremely unsatisfactory fastening method. Exchanging the cloths requires an experienced operator to prevent damage to the cloth when it is clamped in place, and the downtime during the replacement is unjustifiably long.

A certain improvement is achieved by using inflatable seals instead of the string or round cords, which allows a faster insertion or removal of the filter medium. The drum includes a dovetailed flange at both ends into which the inflatable sealing rings are inserted.

Another known method is to fasten the filter cloth in a groove or channel with a quick-action ring.

To explain this fastening method, reference is made below to the schematic drawings in FIG. 1 to FIG. 3D which describe the prior art in some detail. To differentiate between the prior art and the present invention, the reference marks of prior-art embodiments are marked with an apostrophe while those referring to embodiments of the present invention are not marked with an apostrophe.

As an example, FIG. 1 shows a schematic view of a centrifuge drum 1′ from prior art, where a filter cloth 6′ is fastened in peripheral direction 8′ with a quick-action ring 10′ to a channel 700′ cut into the centrifuge drum 1′. As is well-known in prior art, the centrifuge drum 1′ comprises a drum jacket 3′ forming the centrifuge drum 1′ and a drum lid 2′ through which, for example, a suspension to be dehumidified can be inserted through opening 21′. Furthermore, the prior-art centrifuge 1′ is formed by a drum base 200′ not shown for the sake of clarity, which is coupled with a rotary drive (not shown either) that drives the centrifuge drum 1′. The drum jacket 3′ extends in cylinder shape along the longitudinal axis 4′ of the centrifuge drum 1′, and drum lid 2′ and drum base 200′ are arranged diametrically opposite the drum jacket 3′, perpendicular to the longitudinal axis 4′, thus forming the two end surfaces of the cylindrical centrifuge drum 1′.

At an inner peripheral surface 5′ of centrifuge drum 1′, a filter medium 6′, in the current case a textile filter cloth 6′, is provided, whereby, to fix the textile filter cloth 6′, a channel 700′ on the inner peripheral surface 5′ of centrifugal drum 1′ is provided in which the filter cloth 6′ is fixed with clamping ring 10′.

For this, related to the axial longitudinal direction 4′, a hollow seam 61′ extending around the periphery is provided at both ends of filter cloth 6′, into which clamping ring 10′ is inserted before the filter cloth 6′ is installed in centrifuge drum 1′.

Then, filter cloth 6′ is placed on the inner peripheral surface 5′ of centrifuge drum 1′, the hollow seam 61′ is inserted in channel 700′ with clamping ring 10′, and the clamping ring 10′ is clamped, for example, with a quick-action device such that the filter cloth 6′ is firmly fixed in centrifuge drum 1′.

FIG. 2 shows a schematic view of such a clamping ring 10′ which, when applied, lies concentrically to the axial direction of longitudinal axis 4′ of centrifuge drum 1′ (not shown in FIG. 2). Preferably, clamping ring 10′ includes a quick-action device 101′ which allows, for example with a prior-art threading mechanism, to enlarge the circumference of the clamping ring 10′ in channel 700′, thus to clamp the clamping ring 10′ in channel 700′, which securely fixes the filter cloth 6′ in centrifuge drum 1′.

A whole series of quick-action devices 101′ are known in the most varied arrangements which can be used as is practical.

For example, especially easy to handle are quick-action devices 101′ including a ratchet 1011′, in which, for example, two serrated surfaces engage each other which can be moved relative to each other in such a way that the circumference of clamping ring 10′ can be enlarged and the two serrated surfaces lock together such that the larger circumference or the clamping force or locking force thus produced in channel 700′ is automatically maintained. Such quick-action devices 101′ are also well-known in other technical applications. To illustrate, FIG. 2A shows a schematic view of a special embodiment of such a quick-action device 101′.

In the prior art, different embodiments of the channels 700′ running in peripheral direction 8′ can be found which can be of different design depending on requirements or on the specific way of fastening the filter cloth 6′, or which can be provided in different sections of centrifuge drum 1′.

FIG. 3A to FIG. 3D show schematic views of a selection of prior-art types of channels 700′.

FIG. 3A and FIG. 3B show channels 700′ which in FIG. 3A are disposed in drum lid 2′ or in drum base 200′, and which in the example of FIG. 3B are cut into the inner peripheral surface 5′ of drum jacket 3′. The channel configurations according to FIG. 3A and FIG. 3B are preferably used when filter cloth 6′ is pressed into the channel as described above, with a string or a round cord.

FIG. 3C and FIG. 3D on the other hand show channel configurations (channels 700′), which are preferably chosen when, for example, one of the above described clamping ring techniques is used to fix filter cloth 6′ with a clamping ring 10′ in centrifuge drum 1′.

As different as the above described fastening methods and fastening arrangements for fastening a filter medium to a centrifuge drum might be, they are all connected to the same problem that occurs when a channel is used to fasten the filter medium.

Using a channel produces a whole series of disadvantages which are more or less serious, depending on the application.

One of the most important disadvantages is that after the drum itself is welded, i.e. after the drum base and the drum lid are welded together with the drum jacket, the channel for fastening the filter cloth must be introduced, for example cut, into the drum base and/or the drum lid and/or the drum jacket.

In terms of manufacturing technology, this is not only a very big effort, i.e. complicated and thus expensive and not economical, but the cutting and/or flanging of such a channel of course weakens the mechanical strength of the whole drum, since the channels remove material from the drum body that is no longer available for maintaining the stability of the drum, which in the worst case can cause predetermined breaking points. Under certain operating conditions when the centrifuge drum is under great stress, this can lead to cracks or even breakages, i.e. mechanical stresses can occur in the drum material, and the material may even be distorted, which would greatly disturb the rotational symmetry of the centrifuge, requiring a great deal of effort to re-balance it again.

In addition, when the channel is cut into the centrifuge drum, mechanical stresses can occur in the material of the drum or the material might even warp, which would greatly disturb the rotational symmetry of the centrifuge, which can lead to an imbalance in operation, rendering such a centrifuge drum unusable as a result of introducing the channels.

Another considerable disadvantage occurs when high-purity products are centrifuged, which requires maintaining the highest standards (hygiene design), for example in working with high-purity pharmaceutical products where often, in the worst case, the drum must be cleaned after every processed batch. A special problem is correctly cleaning the channel in which the filter cloth is fixed because the channels are difficult to access, and—depending on the geometry of the product—cannot be completely cleaned according to the required purity standard.

Taking the above described problems of a centrifuge drum with a channel into account, another fastening arrangement for fastening a filter medium to a centrifuge drum was suggested in EP 1 935 499 A1.

To explain this type of fastening arrangement, reference is made below to the schematic view shown in FIG. 4. The reference numbers used in FIG. 4 are marked with a prime, since they also relate to prior art.

The centrifuge drum 1′ shown in FIG. 4 comprises a previously known drum jacket 3′ forming centrifuge drum 1′, with discharge openings 31′ through which the liquid phase centrifuged off can be discharged from centrifuge drum 1′, and a drum lid 2′ through which a suspension to be dehumidified can be introduced, for example through discharge hole 21′. Furthermore, centrifuge drum 1′ is formed by a drum base (not shown for reasons of clarity) which is coupled with a rotary drive (also not shown) to drive the centrifuge drum 1′.

Drum jacket 3′ extends cylindrically along longitudinal axis 4′ of centrifuge drum 1′, and drum lid 2′ and the drum base are arranged perpendicular to the longitudinal axis 4′ diametrically opposite drum jacket 3′, thus forming the two end surfaces of the cylindrical centrifuge drum 1′. At an inner peripheral surface 5′ of centrifuge drum 1′, a filter medium 6′ is provided, in the present case a textile filter cloth 6′, and fixed on both ends of centrifuge drum 1′ with a clamping ring 10′.

Relative to the axial longitudinal direction 4′, a hollow seam 61′ extending in peripheral direction 8′ at both ends of filter cloth 6′ is provided into which clamping ring 10′ is inserted prior to installation of filter cloth 6′ in centrifuge drum 1′.

In centrifuge drum 1′ as shown in FIG. 4, to fix the filter cloth 6′ to the inner peripheral surface 5′ of centrifuge drum 1′, a number of fixing clips 7′ are provided, arranged in peripheral direction 8′ at regular intervals. The fixing clips 7, protruding in the direction of the longitudinal axis 4′ of centrifuge drum 1′, extend in peripheral direction 8′ at a predetermined distance to drum lid 2′, such that a second annular fastening space 9′ is formed between drum lid 2′ and fixing clips 7′ to fix filter cloth 6′, and filter cloth 6′ is fastened in fastening space 9′ by clamping ring 10′.

Arranged on the side diametrically opposite drum lid 2′ is the drum base (not shown) which has a number of fixing clips to form a fastening space in which the other end of the cylindrical filter cloth 6′ is also fixed with a clamping ring 10′.

It means that in centrifuge drum 1′ as shown in FIG. 4, related to the axial direction, fixing clips 7′ are disposed at both ends of centrifuge drum 1′ such that for example a filter cloth 6′ can be fixed with a clamping ring 10′ in the first fastening space or a second fastening space 9′.

In the embodiment shown in FIG. 4 of the prior-art fixing arrangement, fixing clips 7′ are designed as welding studs 71′ and welded with a welding gun directly to the corresponding places on drum jacket 3′ of centrifuge drum 1′. After welding, the weld studs 71′ are ground flat to a certain height such that filter cloth 6′ can be laid over the weld studs 71′ without suffering damage and that it is not damaged even under an increased pressure load when the centrifuge is in operation.

Instead of individual fixing clips 7′, a blocking clip rotating continuously in peripheral direction 8′ can be provided which is also welded to the inner peripheral surface 5′ of centrifuge drum 1′.

The fixing clips 7′ can also consist of fixing studs screwed or riveted to drum jacket 3′. In that case, the fixing studs are attached by drilling holes in centrifuge drum 1′ in the places intended for the fixing studs, into which the fixing studs are then screwed, riveted or even welded as is customary.

In the embodiment shown in FIG. 4, the fixing clips 7′ are attached to drum jacket 3′. However, it is also possible to attach the fixing clips 7′ to drum jacket 3′ and/or drum base and/or drum lid 2′.

For installation, filter cloth 6′ is placed on the inner peripheral surface 5′ of centrifuge drum 1′, the hollow seam 61′ with clamping ring 10′ is inserted into the first fastening space or the second fastening space 9′, and the clamping ring 10′ is fixed, for example, with a prior-art quick-action device already described above.

FIG. 4 shows that with the fastening arrangement suggested in EP 1 935 499 A1, there is no need for a channel to fasten filter cloth 6′, since the prior-art function of the channel is replaced by interaction between the fixing clips 7′, 71′ with an adjacent drum lid 2′ and/or drum base and/or drum jacket 3′.

Several improvements could already be achieved in practical operation by applying the described fastening arrangement.

Due to the fact that it is no longer necessary to cut a channel to fix the filter medium such as a filter cloth in the drum lid and/or the drum base and/or the drum jacket, manufacturing the centrifuge drum has become considerably easier and thus more cost-effective than manufacturing the other centrifuge drums known in the prior art with a channel cut in for fixing the filter medium.

Furthermore, the centrifuge drum described in EP 1 935 499 A1 can be cleaned much more easily and more reliably, which plays a crucial role especially in the processing of highly sensitive products where the highest standards of hygiene must be applied such as (but not exclusively) high-purity pharmaceutical products.

However, it has also become evident that even this improved fastening arrangement, which has proven itself in practical application in the meantime, still has potential for more improvement.

A considerable disadvantage of the fastening arrangement is that after welding the drum itself, i.e. after welding together the drum base and the drum lid with the drum jacket, the fixing clips must be subsequently welded, screwed or riveted to the drum jacket and/or the drum lid and/or the drum base or otherwise installed in the centrifuge drum.

In retrospect, it was found that the installation of the fixing clips also involves considerable technical complexity in the manufacture of drums, i.e. contrary to original expectations, the attachment of the fixing clips to the drum is quite complicated and thus expensive and not economical. Furthermore, welding and/or adding additional holes significantly weakens mainly the mechanical stability of the whole drum, since—just as when cutting a channel—welding and/or drilling removes material from the drum body that is no longer available to maintain the drum's stability during its enormously high rotational speeds, and/or in the worst case, this can cause predestined breaking points, which under certain operating conditions, when the centrifuge drum is under great stress, can lead to cracks or even breakages. I.e. mechanical stresses can occur in the material of the drum, and the material may even be distorted, which would greatly disturb the rotational symmetry of the centrifuge drum, requiring a greater effort to re-balance it again.

In addition, in case of welding, or when the holes are drilled into the centrifuge drum, it can happen that mechanical stresses occur in the material of the drum or there might even be a distortion of the material, which would disturb the rotational symmetry of the centrifuge drum, which can lead to an imbalance in operation, rendering such a centrifuge drum unusable as a result of subsequent welding and/or the drilling of holes.

Furthermore, screwing the fixing clips to the centrifuge drum turned out to be difficult and time-consuming since there is limited space between the centrifuge drum and the centrifuge housing. Therefore, applying the nut necessary for bolting the fixing clips from outside the drum requires great skill and therefore experienced staff. That is a problem particularly when retrofitting the fixing clips, when the fixing clips must be attached to a centrifuge drum that is already inside the centrifuge housing. It was also found that due to the extremely high rotational speed of the centrifuge drum, the screw connections between the fixing clips and the centrifuge drum can become loose. This causes the potential risk that a loose nut in the outside of the centrifuge drum is accelerated toward the outside, causing considerable damage to the centrifuge and adjacent components or even personal injury.

It is also a considerable disadvantage of the fixing arrangement with fixing clips that structural modifications are necessary for the original centrifuge drum, i.e. modifications of the drum base, the drum lid and/or the drum jacket. These structural modifications can only be reversed with considerable effort, which means that returning the centrifuge drum to its original state is very difficult to achieve. However, such conversion is often required, for example to adapt the type of fixing arrangement to the application of the centrifuge drum.

It is therefore the object of the invention to provide a further improved centrifuge drum in which a filter medium, in particular a textile filter cloth, can be installed or replaced particularly simply, quickly and reliably in the centrifuge drum that has the greatest mechanical stability and few structural modifications, such that disadvantages known from prior art can be largely avoided.

The subject matter of the invention capable of achieving this object are described herein.

Additional advantageous embodiments of the invention are further described herein.

Thus, the invention relates to a centrifuge drum for a centrifuge for dividing a mixture into a solid material cake and a liquid phase, comprising a drum lid, a drum base and a drum jacket all forming the centrifuge drum, whereby the drum jacket extends along a longitudinal axis of the centrifuge drum, and at the drum jacket in radial direction to the longitudinal axis, a number of discharge holes with a discharge diameter are arranged, and the drum lid and the drum base are arranged perpendicular to the longitudinal axis, diametrically opposite at the drum jacket. The drum lid, the drum base and the drum jacket together enclose an interior space of the centrifuge drum. In the installed state, the centrifuge drum is rotatable inside the centrifuge around the longitudinal axis, while in the operating state it is rotatable around the longitudinal axis by a drive with a predeterminable rotational speed; at an inner peripheral surface of the drum jacket, a filter medium is provided which is fixed to the inner peripheral surface of the drum jacket with at least one fixing arrangement.

According to the invention, the fixing arrangement comprises a fixing socket extending along a socket axis, with a fixing collar, whereby the fixing socket is arranged from the interior space of the centrifuge drum in one of the drainage holes, such that the filter medium is fixed by the fixing collar on the inner peripheral surface of the drum jacket in radial direction to the longitudinal axis.

The fixing socket comprises a fixing shaft and a fixing collar or fixing flange. The fixing shaft can have any profile, preferably a round or angular profile, and extends along a socket axis. In the installed state, the fixing socket, with a free end of the fixing shaft, extends into one of the discharge holes of the drum jacket such that the fixing collar clamps or fixes the filter medium to the inner peripheral surface of the drum jacket. This means that in the installed state, the fixing shaft of the fixing socket is arranged axially parallel to a central axis of the discharge hole extending radially to the longitudinal axis of the centrifuge drum.

According to the invention, the fixing socket can in principle be arranged in any of the discharge holes of the drum jacket. However, it has been proven advantageous when a fixing socket is arranged in a number of discharge holes at regular intervals in peripheral direction of the drum jacket, such that an equal fixation of the filter medium is achieved at the inner peripheral surface of the drum jacket.

This means that preferably, related to the axial direction, a number of fixing sockets is disposed at both ends of the centrifuge drum, such that the filter medium is fixed to the peripheral surface of the drum jacket.

The advantages of the centrifuge drum according to the invention are obvious.

Since it is no longer necessary to cut a channel or apply a fixing clip to fix the filter medium in the drum lid and/or drum base and/or drum jacket, manufacturing the centrifuge drum is considerably simplified and therefore more economical than producing prior-art centrifuge drums with a cut-in channel or an attached fixing clip for fixing the filter medium. Furthermore, the centrifuge drum according to the invention has much better mechanical stability because it is no longer necessary to cut out the channel or drill additional holes for the fixing clips and to remove material from the centrifuge drum, which in the prior art led to a mechanical weakening of the material at the affected points or sections.

Furthermore, the fixing arrangement in the form of a fixing socket with a fixing collar according to the present invention is easier and quicker to fasten to the inner peripheral surface of the drum jacket of the centrifuge drum, and even older centrifuge drums already in operation, such as those with fixing nuts or fixing clips as the centrifuge drums described in detail in connection with FIG. 1 to FIG. 4 can be converted without much effort, i.e. without structural changes to the drum lid, the drum base and the drum jacket, to become a centrifuge drum according to the invention, by subsequently installing the fixing sockets in discharge holes of the drum jacket. This is an interesting version especially when in an older centrifuge drum the existing fixing arrangement has later on turned out to be a negative factor, for example because changing the filter medium is difficult and time-consuming due to the existing fixing arrangement.

Thus it is possible, for example, to convert a centrifuge drum of the type according to FIG. 4, which is only suitable for filter cloths that are pressed into a fastening space by a clamping ring, as described above, such that filter cloths can be used without clamping rings by subsequently attaching fixing sockets according to the present invention to existing discharge holes in the inner peripheral surface of the drum jacket of the centrifuge drum.

Converting an existing prior-art centrifuge drum to a centrifuge drum according to the invention can be worthwhile in various cases, for example because fixation of the filter medium in a centrifuge drum according to the invention is much simpler, faster and less prone to error, and a conversion to a centrifuge drum according to the invention is worthwhile especially when frequent filter cloth changes are necessary.

A particularly important advantage of the invention that should be emphasized is that the conversion of a prior-art centrifuge drum can also be performed on site at the customer's location without the necessity of removing the centrifuge drum from the centrifuge for converting it into a type according to the invention. It means that an older centrifuge drum can be easily converted inside the centrifuge in the installed state by way of on-site maintenance directly at the customer's location.

Furthermore, in the centrifuge drum according to the invention, two different alternatives of fastening methods can be easily combined, i.e. a prior-art fastening method can be combined with the fastening method according to the invention. Such a combination of two different fastening methods is possible only with the invention, since it does not require the implementation of any additional structural modifications of the centrifuge drum. This makes it possible to make maximum use of the individual advantages offered by different fastening methods.

Moreover, it is simple and quick to apply a fixing socket to the centrifuge drum, since the fixing socket is attached directly from inside the centrifuge drum. Therefore, converting an existing centrifuge drum into a centrifuge drum according to the invention can be accomplished by less experienced staff. The centrifuge drum according to the invention also has no attachments outside the drum jacket, which has the positive effect that no parts can be accelerated radially toward the outside to cause damage to the centrifuge and to adjacent components or to cause personal injury.

The filter medium itself is, for example, a filter cloth and/or a supporting fabric, preferably a textile filter cloth and/or a textile support fabric, in particular a filter cloth and/or support fabric of plastic, especially a filter cloth and/or support fabric of polypropylene and/or a filter cloth and/or a support fabric of metal and/or a filter cloth and/or support fabric of a composite material, especially of a carbon composite and/or a filter cloth and/or a support fabric of another suitable material.

The support fabric usually disposed between the filter cloth and the inner peripheral surface of the drum jacket prevents that the filter cloth, due to the centrifuge drum's enormously high rotational speed, is pulled into the discharge holes, and that the discharge holes are plugged by the filter cloth. Thus, the support fabric ensures that the liquid phase centrifuged off is conducted safely from the centrifuge drum toward the outside.

Thus, in the centrifuge drum according to the invention, a filter cloth or a support fabric, or a filter cloth and a support fabric, are arranged at the inner peripheral surface of the drum jacket. In the former case, the centrifuge drum has only a filter cloth, and in the latter case, the centrifuge drum has only a support fabric, and each support fabric is fastened to the inner peripheral surface of the drum jacket according to the invention, i.e. with a fixing socket. In the latter case, where the centrifuge drum has both a filter cloth and a support fabric, it is possible on the one hand that the support fabric is firmly connected with the inner peripheral surface of the drum jacket, for example by a weld connection, and the filter cloth abuts loosely to the support fabric, whereby the filter cloth according to the invention is firmly connected to the inner peripheral surface of the drum jacket. On the other hand, it is also possible for the filter cloth to be firmly connected with the support fabric, for example via an adhesive bond, and that the support fabric according to the invention is connected via a fixing socket to the inner peripheral surface of the drum jacket. It is self-evident that the centrifugal drum according to the invention can also comprise a combination of the above named fastening possibilities.

In one embodiment, a first outer socket diameter of the fixing socket is larger than the discharge diameter of the discharge holes. The first outer socket diameter in the non-installed state of the fixing socket is larger than the discharge diameter of the discharge holes, whereas in the installed state, the first outer socket diameter and the discharge diameter of the discharge holes are identical. Therefore in this embodiment, the fixing socket and the discharge hole together form a press fit, i.e. to fix the filter medium on the inner peripheral surface of the drum jacket, the fixing socket is installed, for example with a hammer, or pressed into one of the discharge holes.

In one preferred embodiment, a first and/or a second outer socket diameter of the fixing socket is smaller than the discharge diameter of the discharge holes. In this embodiment, for example, a separate sleeve in the form of a dowel is inserted in the discharge hole, whereby the fixing socket is designed as a screw with a screw shaft and a screw head, and in the installed state it is screwed into the sleeve, and the filter medium is fixed with the screw head to the inner peripheral surface of the drum jacket. To provide the screw with a firmly defined clamping position, the screw shaft has two different outer shaft diameters, a first larger outer shaft diameter and a second smaller outer shaft diameter, whereby both shaft diameters are smaller than the discharge diameter of the discharge holes. This design of the screw shaft ensures that the screw is firmly wedged in the discharge hole at the position of its first larger shaft diameter, which includes an outer thread.

However, the embodiment may, for example, also be designed such that in one of the discharge holes at least one locking element in the form of a sleeve is provided, which has a partial section flexibly deflectable in radial direction toward the socket axis, and where the fixing socket has a recess in an exterior peripheral surface, in particular a circumferential recess, whereby in operating position, the flexibly deflectable partial section extends into the recess of the fixing socket and secures the fixing socket in the direction of the socket axis, i.e. the fixing socket is not fastened as in the above described example by a screw connection, but by a plug-in connection in one of the discharge holes. Due to the plug-in connection, the fixing socket can be simply and quickly installed or disassembled. The fixing socket has a first and in the area of the recess a second exterior socket diameter, both of which are smaller than the discharge diameter of the discharge holes.

In another embodiment, the fixing socket along the socket axis has a socket hole, in particular a socket passage hole, over at least part of its length. Thanks to the socket hole, the weight of the centrifuge drum according to the invention can be greatly reduced, which has a particularly positive effect on the acceleration of the centrifuge drum from standstill. The socket passage hole also ensures that the liquid phase centrifuged off is securely discharged to the outside in spite of the fixing arrangement, i.e. the socket passage hole ensures that the discharge holes are not unnecessarily blocked when the fixing arrangement is used.

It has also proven to be beneficial when the fixing socket has a socket groove or a socket slot tangential to the socket hole. The socket groove is arranged on the fixing shaft of the fixing socket, has a width of 2-10 mm and extends from a free end of the fixing shaft in the direction of the fixing collar. In the installed state, thanks to the socket groove, the fixing socket can be spread apart, achieving a better clamping effect for the fixing socket in the discharge hole.

Preferably, but not necessarily, the socket groove or the socket slot can be aligned parallel to the longitudinal axis of the centrifuge drum, i.e. the socket groove is aligned parallel to a short elliptical axis of the discharge hole. For that purpose, the fixing sockets are spread apart in the direction of a long elliptical axis of the discharge hole, which allows for the optimal clamping of the fixing socket, also securing it against rotation.

In an embodiment of particularly practical importance, the fixing arrangement comprises, in addition to the fixing socket, a clamping bolt arranged inside the socket hole. In the installed state of the fixing socket, the clamping bolt causes the first and/or second outer socket diameter to spread, thus achieving a clamping effect between the fixing socket and the interior surface of the discharge hole. The clamping bolt can have a variety of shapes. In a first version, the clamping bolt is designed as a clamping pin which is—at least partly—hammered or pressed into the socket hole. In a second version, the clamping bolt can also be designed as a rivet that is riveted to the fixing socket. In another version, it is also possible for the clamping bolt not to be cylindrical but to have a globular form.

In this embodiment, it has also proven beneficial if the clamping bolt is designed as a fixing screw and if the socket hole has a socket thread in which the fixing screw is bolted to the fixing socket. In the installed state of the fixing socket, the fixing screw causes the first and/or second outer socket diameter to spread apart, which has a clamping effect between the fixing socket and the interior surface of the discharge hole. The fixing screw can also have different designs, for example as a countersunk screw or as a stud screw.

It is also quite conceivable that the fixing arrangement—in addition to the fixing socket and the fixing screw—has an expansion wedge in the shape of a truncated cone with an inner thread, where the fixing socket, in addition to the fixing collar and the fixing shaft has a passage hole, which at one free end of the fixing shaft becomes a widening conical hole. The conical expansion wedge in the shape of a truncated cone has a shape matching the conical hole and in the installed state establishes a positive fit with the conical hole. If the fixing screw is screwed into the inner thread of the expansion wedge, the expansion wedge expands, clamping the fixing socket to the inner surface of the discharge hole.

Preferably, the fixing collar of the fixing socket has a round shape, such that the fixing collar has a collar diameter. In practice it has been found that a round fixing collar provided sufficient clamping or fixing of the filter medium to the inner peripheral surface of the drum jacket, at the same time avoiding that the fixing collar damages the filter medium.

Alternatively, of course, the fixing collar can also be of angular shape, such that the fixing socket can be simple fitted into the discharge hole with a wrench. This greatly simplifies fixing the filter medium to the interior peripheral surface of the drum jacket.

In manufacturing the drum jackets, a plain sheet metal including cylindrical discharge holes is passed into the cylindrical contour of the drum jacket, which stretches the material on the outside of the drum jacket and compresses it at the inner peripheral surface of the drum jacket. This causes the originally cylindrical form of the discharge holes to take on a slightly conical form, i.e. the manufactured drum jacket has slightly conical discharge holes, such that the discharge diameter of the discharge holes is not constant but continually enlarges from the inner peripheral surface in radial direction to the outer surface of the drum jacket. Due to the slightly conical discharge holes, the fixing socket in the discharge hole is pulled backwards, i.e. in the direction of the outer surface of the drum jacket, which has the positive effect that in all above described embodiments of the invention, the clamping effect of the fixing collar, i.e. the clamping effect between the fixing collar and the filter medium, is further increased.

In very general terms, it can be emphasized that all prior-art fixing methods and the associated filter media or fixing cloths which are suitable for fixing in prior art, and some of which have already been described above, can be used advantageously in a centrifuge drum according to the invention.

A centrifuge drum according to the invention can always be used advantageously in any kind of centrifuge. Therefore the invention also concerns a centrifuge, in particular a vertically or horizontally oriented centrifuge, a continually or discontinually operating centrifuge, especially a peeler centrifuge, a sliding discharge centrifuge, a one-stage or two-stage pusher centrifuge, a double pusher centrifuge or an oscillating centrifuge with a centrifuge drum according to the present invention.

### BRIEF DESCRIPTION OF THE DRAWINGS

The invention will be explained in more detail hereinafter with reference to the drawings.

FIG. 1 shows a prior-art centrifuge drum;

FIG. 2 shows a first embodiment of a prior-art quick-action ring:

FIG. 2A shows a second embodiment of a prior-art quick-action lock;

FIG. 3A shows a first embodiment of a prior-art centrifuge drum with a fixing groove;

FIG. 3B shows a second embodiment according to FIG. 3A;

FIG. 3C shows a third embodiment according to FIG. 3A;

FIG. 3D shows a fourth embodiment according to FIG. 3A:

FIG. 4 shows a first embodiment of a prior-art centrifuge drum with a fixing clip;

FIG. 5 shows a first embodiment of a centrifuge drum according to the invention;

FIG. 6 shows a first embodiment of a converted centrifuge drum according to FIG. 1;

FIG. 7 shows a perspective view of a fixing socket with a fixing collar;

FIG. 8A shows a detail of a first embodiment of a fixing arrangement according to FIG. 5 and FIG. 6;

FIG. 8B shows a second embodiment according to FIG. 8A;

FIG. 8C shows a third embodiment according to FIG. 8A;

FIG. 8D shows a fourth embodiment according to FIG. 8A;

FIG. 8E shows a fifth embodiment according to FIG. 8A;

FIG. 8F shows a sixth embodiment according to FIG. 8A;

### DETAILED DESCRIPTION OF THE EMBODIMENT

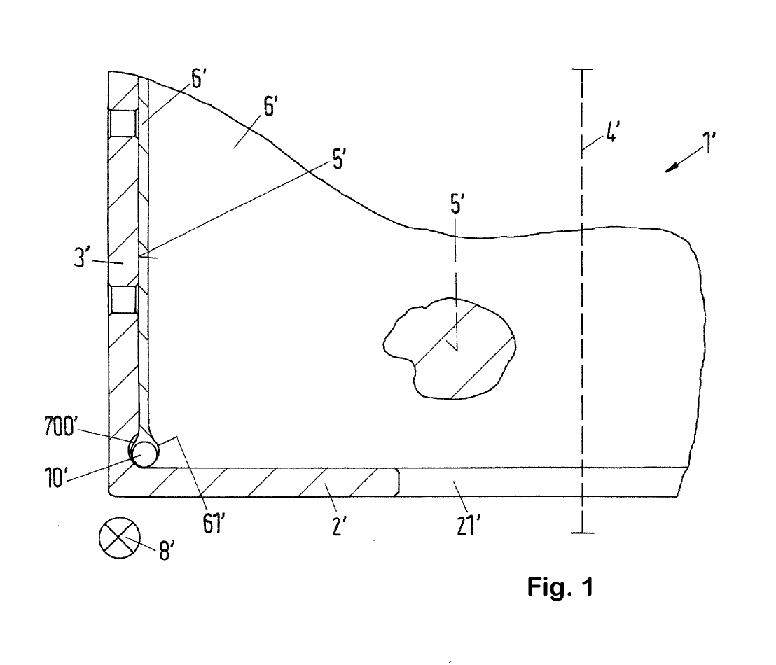

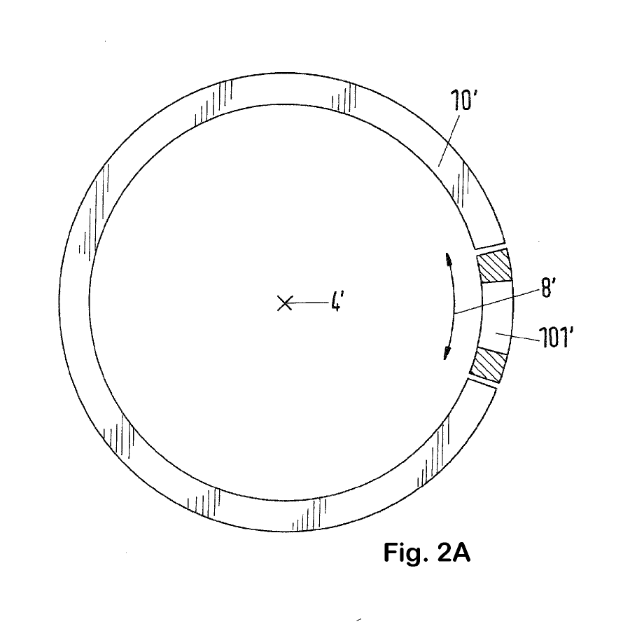

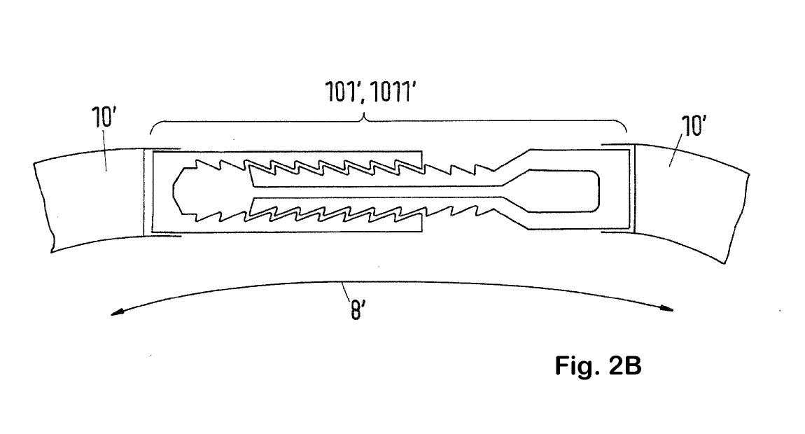

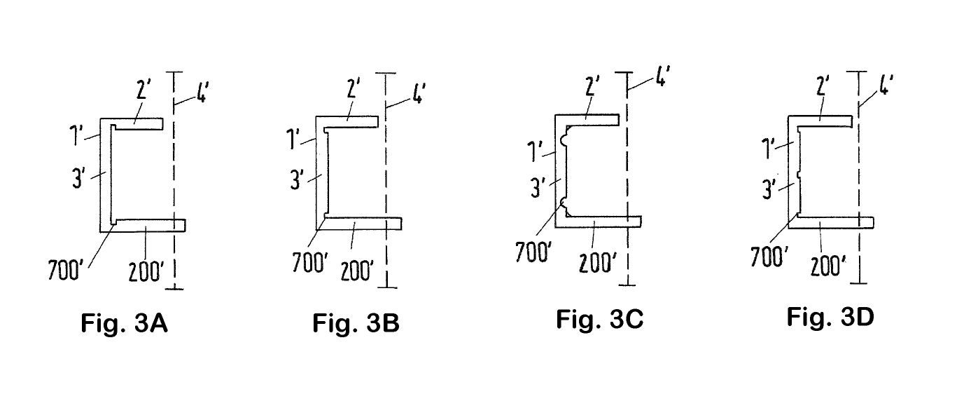

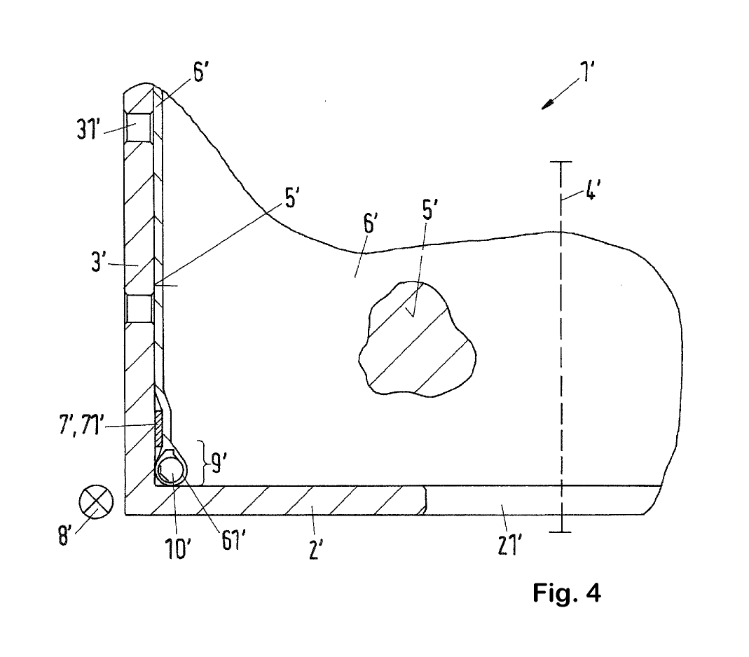

As already mentioned, FIG. 1 to FIG. 4 show the prior art which was already discussed earlier, and no further discussion is therefore required here.

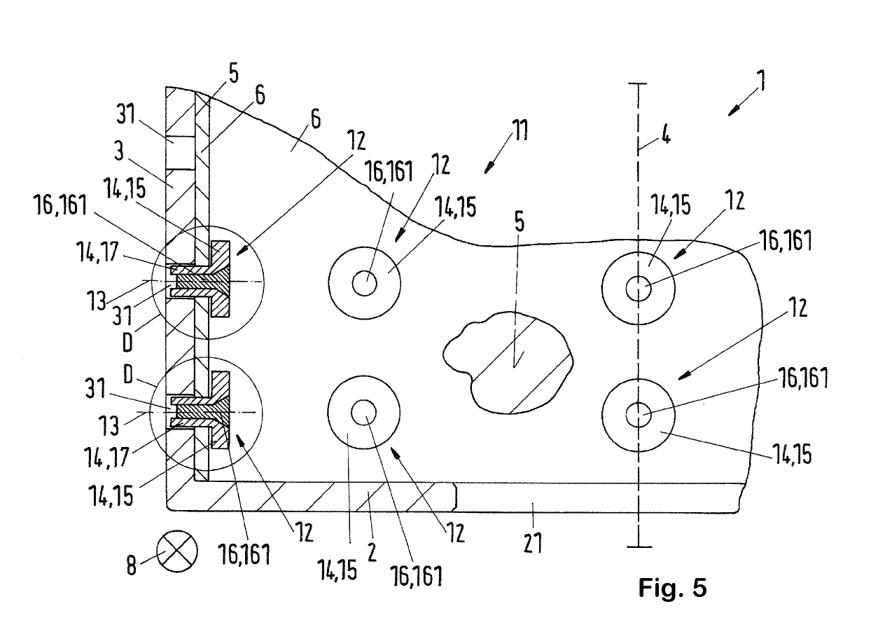

FIG. 5 shows in cross-section a partial schematic view of a first embodiment of a centrifuge drum according to the invention, which hereinafter is marked with the overall reference number 1. The reference numbers used in FIG. 5 to FIG. 8F have no apostrophe, since these figures relate to embodiments of the present invention. As already mentioned above, only the reference numbers in FIG. 1 to FIG. 4 have an apostrophe, since they refer to the prior art.

As is known from prior art, centrifuge drum 1 comprises a drum jacket 3 that actually forms the centrifuge drum 1, with discharge holes 31 through which the liquid phase is to be centrifuged off from centrifuge drum 1, and a drum lid 2 through whose hole 21, for example, a suspension to be dehumidified can be introduced. Furthermore, centrifuge drum 1 is also formed by a drum base (not shown for the sake of clarity) coupled with a rotary drive (also not shown) for driving centrifuge drum 1.

Drum jacket 3 extends cylindrically along the longitudinal axis 4 of centrifuge drum 1, and drum lid 2 and the drum base are arranged vertically to longitudinal axis 4, diametrically opposite at drum jacket 3, forming the two end surfaces of the cylindrical centrifuge drum 1, drum lid 2, the drum base and drum jacket 3 together enclose an inner space 11 of centrifuge drum 1.

In the case of centrifuge drum 1 according to the invention, shown in FIG. 5, a filter cloth 6 is fastened to an inner peripheral surface 5 of drum jacket 3 with a number of fixing arrangements 12. The fixing arrangements 12 each comprise a fixing socket 14 extending along a socket axis 13 with a fixing collar 15 and a clamping bolt 16. The fixing sockets 14 are arranged from inner space 11 of centrifuge drum 1 in one of the discharge holes 31 such that the filter cloth 6 is fixed by fixing collar 15 on the inner peripheral surface 5 of drum jacket 3 in radial direction to the longitudinal axis 4. Clamping bolt 16 is designed as a fixing screw 161, screwed via a socket thread to fixing socket 14. In the installed state, fixing screw 161 causes fixing shaft 17 of fixing socket 14 to spread apart, thus clamping fixing socket 14 to an inner surface of discharge hole 31.

Related to the axial direction of centrifuge drum 1, the fixing arrangements 12 are arranged at both ends of centrifuge drum 1, i.e. at the upper and lower side of drum jacket 3. Fixing arrangements 12 are arranged at regular intervals in peripheral direction 8 of drum jacket 3 in a number of discharge holes 31 in such a way that filter cloths 6 can be equally fixed on the inner peripheral surface 5 of drum jacket 3.

For installation, filter cloth 6 is then placed on the inner peripheral surface 5 of centrifuge drum 1, fixing sockets 14 are inserted in the appropriate discharge holes 31 and secured by fixing screws 161 in axial direction to socket axis 13, thus fixing filter cloth 6 to the inner peripheral surface 5 of drum jacket 3 by fixing collars 15.

Thus FIG. 5 clearly shows that thanks to the present invention, there is no need for a channel or additional holes in drum jacket 3 for fastening filter cloth 6.

With the embodiment shown in FIG. 5 it is quite conceivable that instead of the filter cloth, a support fabric can be fastened to the inner peripheral surface of the drum jacket with a number of fixing arrangements.

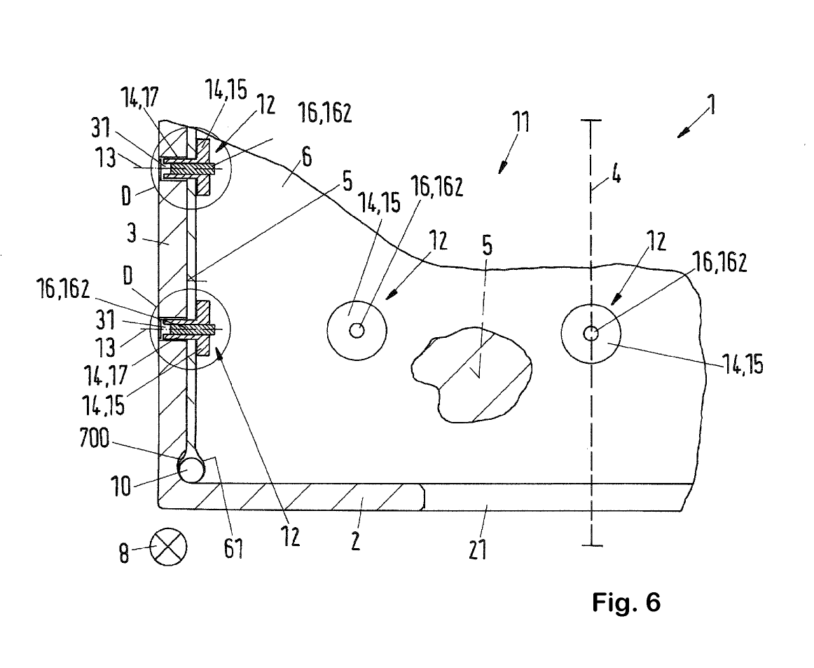

FIG. 6 shows in cross-section a schematic view of a part of a first embodiment of a converted centrifuge drum according to FIG. 1.

As known from prior art, centrifuge drum 1 comprises a drum jacket 3 forming centrifuge drum 1, with discharge holes 31, through which the liquid phase to be centrifuged off is discharged from centrifuge drum 1, and a drum lid 2 through which a suspension to be dewatered can be introduced, for example through hole 21. Furthermore, the prior-art centrifuge drum 1 is formed by a drum base (not shown in FIG. 6 for the sake of clarity) which is coupled with a rotary drive (also not shown) to drive centrifuge drum 1. Drum jacket 3 extends cylindrically along longitudinal axis 4 of centrifuge drum 1, and drum lid 2 and the drum base are arranged vertically to the longitudinal axis 4, diametrically opposite drum jacket 3, thus forming the two end surfaces of cylindrical centrifuge drum 1. Drum lid 2, the drum base and drum jacket 3 together enclose an inner space 11 of centrifuge drum 1.

At an inner peripheral surface 5 of drum jacket 3, a filter medium 6, in the present case a textile filter cloth 6, is provided, whereby two different fastening methods are used to fix filter cloth 6: the fastening method known from the centrifuge drum shown in FIG. 1, and fastening method according to the invention.

Using the prior-art fastening method, centrifuge drum 1, as described above in relation to FIG. 1, comprises—at both ends of inner peripheral surface 5 of drum jacket 3—a cut-in channel 700 in which filter cloth 6 is fixed with a clamping ring 10. Related to the axial longitudinal direction 4, a circumferential hollow seam 61 is disposed at both ends of filter cloth 6 in peripheral direction 8, into which clamping ring 10 is inserted prior to installation of filter cloth 6 in centrifuge drum 1.

For fixing filter cloth 6, centrifuge drum 1 also comprises a large number of fixing arrangements 12 according to the invention, which are arranged at regular intervals in peripheral direction 8 of drum jacket 3 in a number of discharge holes 31. The fixing arrangements 12 each comprise a fixing socket 14 extending along a socket axis 13, with a fixing collar 15 and a clamping bolt 16. Fixing sockets 14 are arranged from interior space 11 of centrifuge drum 1 in one of the discharge holes 31 such that filter cloth 6 is fixed not only by the two clamping rings 10, but also by fixing collar 15 to the inner peripheral surface 5 of drum jacket 3 in radial direction to longitudinal axis 4. Clamping bolt 16 is designed as a clamping pin 162, which is hammered or pressed into a socket hole 19 of fixing socket 14. Clamping pin 162 causes a fixing shaft 17 of fixing socket 14 to spread apart, which causes clamping between fixing socket 14 and an inner surface of discharge hole 31.

For the sake of clarity, FIG. 6 illustrates only the fastening of filter cloth 6 in the area of drum lid 2. On the side diametrically opposite drum lid 2, i.e. in the area of the drum base, filter cloth 6 is also fixed with a clamping ring 10 and a large number of fixing arrangements 12 according to the invention, to the inner peripheral surface 5 of drum jacket 3.

For installation, filter cloth 6 is placed on inner peripheral surface 5 of centrifuge drum 1, the hollow seam 61 is inserted with clamping ring 10 into channel 700 on drum lid 2 and the drum lid (not shown and clamping ring 10 is fixed, for example with a quick-action device, that is actually prior art and was already discussed above. Furthermore, the fixing sockets 14 are inserted into the appropriate discharge holes 31 and secured by clamping pin 162 in axial direction to socket axis 13, which additionally fixes filter cloth 6 to the inner peripheral surface 5 of drum jacket 3 by fixing collar 15 of fixing socket 14. Thus, FIG. 6 explicitly illustrates that the present invention allows the combination of two different fastening methods, such that a prior-art centrifuge drum can be retrofitted with a fixing arrangement 12 according to the invention.

FIG. 7 shows a perspective view of a fixing socket 14. Fixing socket 14 comprises a fixing shaft 17 and a fixing collar 15. Fixing shaft 17 extends along a socket axis 13 and has a round profile with an outer socket diameter 20. As FIG. 5 and FIG. 6 indicate, in the installed state, fixing socket 14 with fixing shaft 17 extends into one of the discharge holes 31 of drum jacket 3 such that fixing collar 15 clamps filter cloth 6 or fixes it to the inner peripheral surface 5 of drum jacket 3. Fixing socket 14 has a socket hole 19 along socket axis 13. Fixing socket 14 also has a socket groove 21 across socket hole 19. Socket groove 21 is arranged on fixing shaft 17 of fixing socket 14 and extends from a free end of fixing shaft 17 in the direction of fixing collar 15. Thanks to socket groove 21, fixing shaft 17 can be spread apart in the installed state, which improves the clamping effect of fixing socket 14 in discharge hole 31. In this embodiment, the fixing collar has a round form.

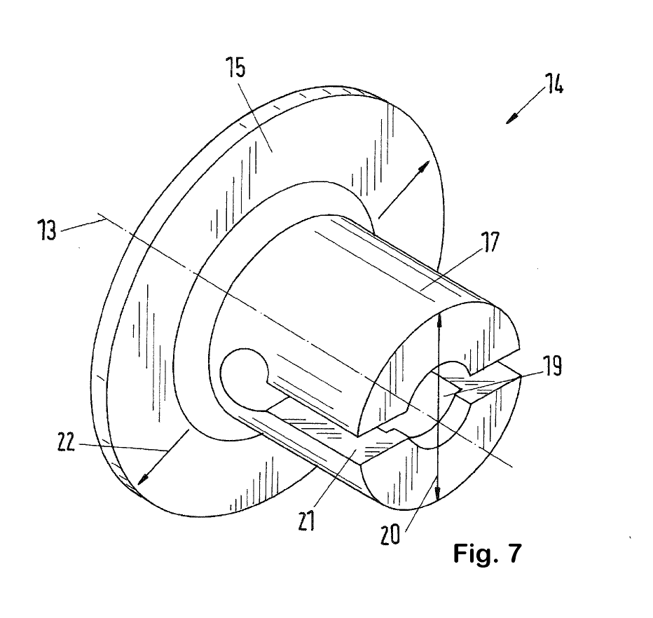

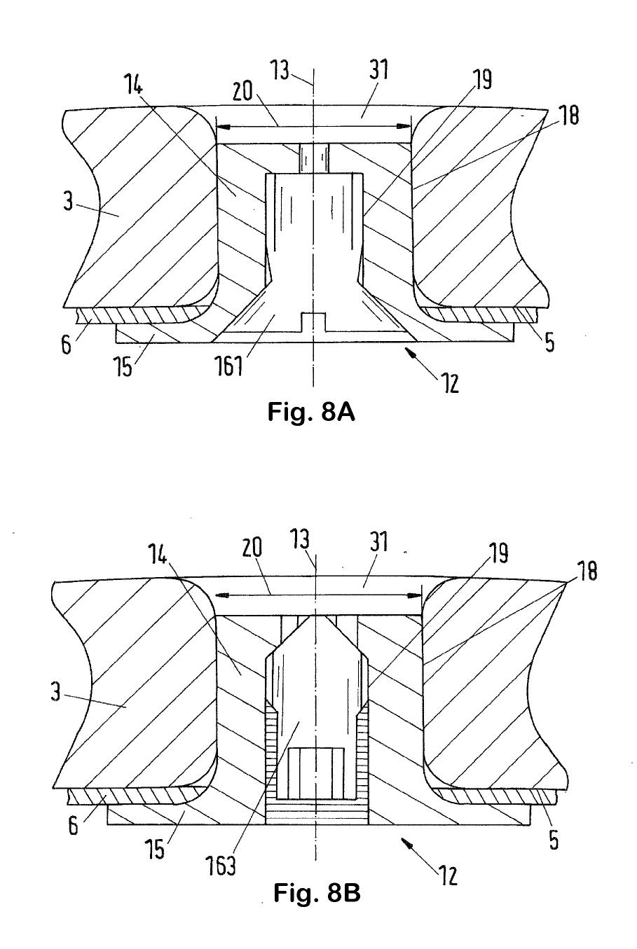

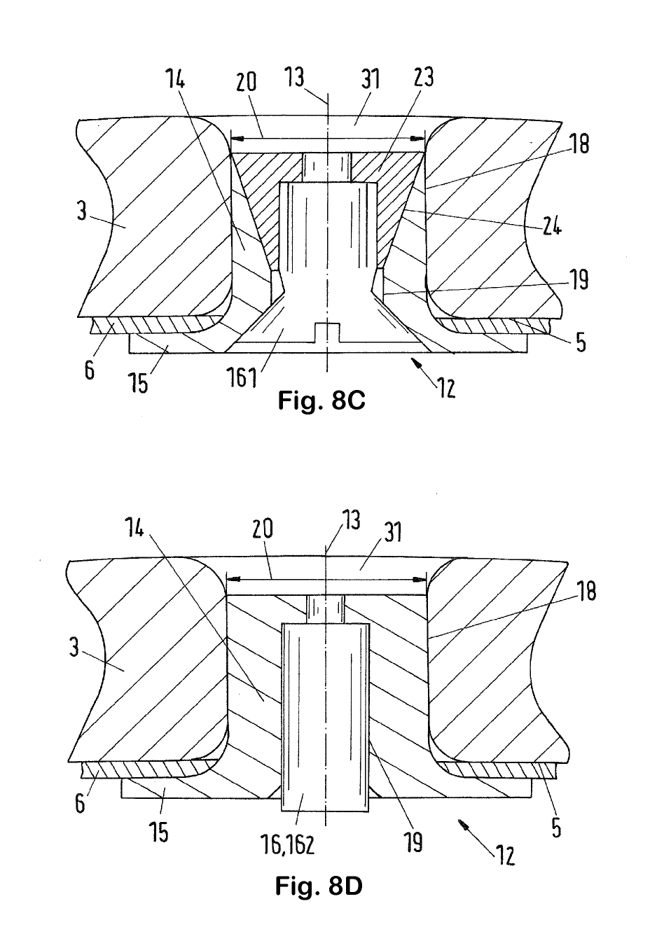

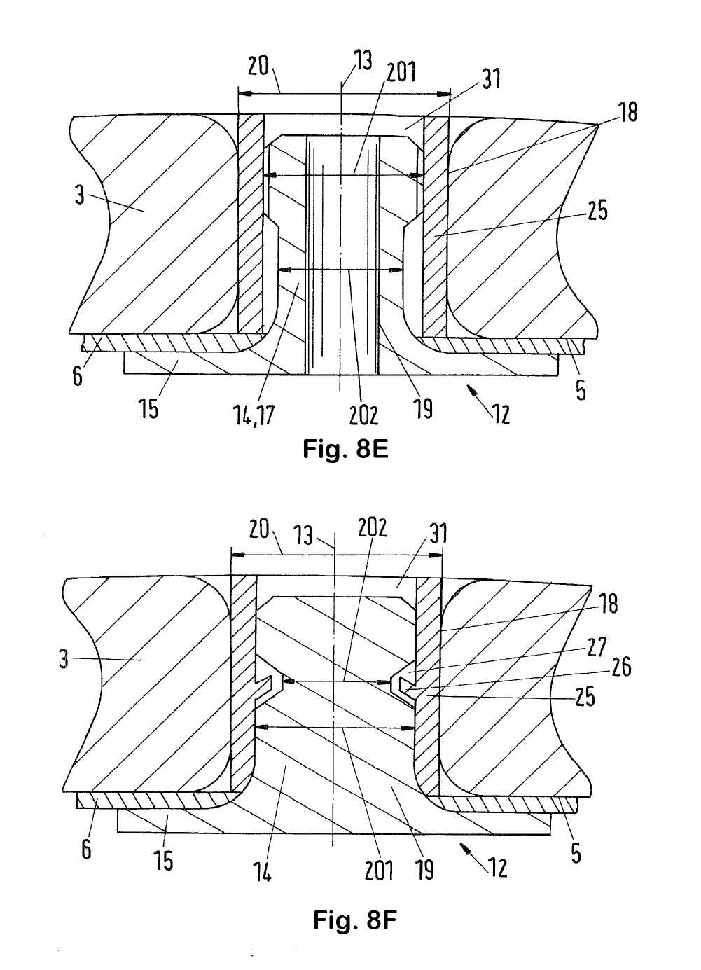

FIG. 8A to FIG. 8F show an enlargement of detail D shown in FIG. 5 and FIG. 6, where the above named figures illustrate different embodiments of fixing arrangement 12 according to the invention.

FIG. 8A shows a first embodiment of fixing arrangement 12 according to the invention. Fixing arrangement 12 comprises a fixing socket 14 and a fixing screw 161 in form of a countersunk screw. Fixing socket 14 extends along a socket axis 13 and includes a socket hole 19 with a socket thread. Via the socket thread, fixing screw 161 is screwed together with fixing socket 14. In the installed state of fixing socket 14, fixing screw 161 causes an outer socket diameter 20 of fixing socket 14 to spread apart which allows clamping between fixing socket 14 and an inner surface 18 of discharge hole 31. Thanks to this clamping, filter cloth 6 is fixed by fixing collar 15 of fixing socket 14 to the inner peripheral surface 5 of drum jacket 3.

As FIG. 8B indicates, the countersunk screw can also be replaced by a stud screw to produce the clamping effect between fixing socket 14 and inner surface 18 of discharge hole 31.

FIG. 8C shows another embodiment of the fixing arrangement 12 according to the invention. Here, the fixing arrangement 12, in comparison with the embodiments shown in FIG. 8A and FIG. 8B, in addition to fixing socket 14 and fixing screw 161 show a truncated expansion wedge 23 with an inner thread. Fixing socket 14 has a socket hole 19 without inner thread, whereby socket hole 19, at a free end of fixing socket 14, becomes a widening conical hole 24. The truncated expansion wedge 23 is designed to fit conical hole 24 and in the installed state forms a positive fit with conical hole 24. If fixing screw 161 is screwed into the inner thread of expansion wedge 23, fixing socket 14 spreads out, achieving a clamping between fixing socket 14 and inner surface 18 of discharge hole 31. Also in this embodiment, filter cloth 6 is fixed due to clamping by a fixing collar 15 of fixing sockets 14 to the inner peripheral surface 5 of drum jacket 3.

According to FIG. 8D, fixing arrangement 12 can—in addition to fixing socket 14—have a clamping bolt 16 in the form of a clamping pin 162. Fixing socket 14 corresponds to fixing socket 14 shown in FIG. 7, whereby clamping pin 162 is hammered or pressed into a socket hole 19 of fixing socket 14. In the installed state, clamping pin 162 causes fixing socket 14 to spread apart, achieving a clamping effect between fixing socket 14 and an inner surface 18 of discharge hole 31. As in the preceding embodiments, filter cloth 6 is clamped by a fixing collar 15 of fixing socket 14 to the inner peripheral surface 5 of drum jacket 3. But as an alternative it is also possible that clamping bolt 16, instead of being a clamping pin 162, is designed as a rivet that is riveted to fixing socket 14.

In the embodiments shown in FIG. 8E and FIG. 8F, fixing arrangement 12 is additionally includes a separate sleeve 25 inserted in discharge hole 31 of drum jacket 3. In this case, sleeve 25 is designed as a dowel.

In FIG. 8E, fixing socket 14 has the form of a screw. In the installed state, fixing socket 14 is screwed into sleeve 25 inserted in discharge hole 31, whereby filter cloth 6 is fixed by a fixing collar 15 to the inner peripheral surface 5 of drum jacket 3. To provide fixing socket 14 in discharge hole 31 with a firm clamping point, a fixing shaft 17 of fixing socket 14 has two different outer socket diameters, a first larger, outer socket diameter 201 and a second smaller outer socket diameter 202, whereby the first larger outer socket diameter 201 includes an outer thread. Due to the two different socket diameters, it is achieved that fixing socket 14 is wedged into discharge hole 31 in the position of the first larger socket diameter 201.

As FIG. 8F indicates, sleeve 25 in discharge hole 31 can also include partial section 26 that is flexibly deflectable in radial direction to socket axis 13, and fixing socket 14 can have a circumferential recess 27 at an outer peripheral surface, whereby in operating position, the flexibly deflectable partial section 26 extends into recess 27 of fixing socket 14, securing fixing socket 14 in the direction of socket axis 13. This means that fixing socket 14 is not fastened, as shown in FIG. 8E, via a screw connection, but via a plug-in connection in one of the discharge holes 31. Fixing socket 14 has a first outer socket diameter 201, with which fixing socket 14 abuts to sleeve 25, and in the area of recess 27, it has a second outer socket diameter 202.

In the embodiments of a fixing arrangement 12 according to the invention, shown in FIG. 8A to FIG. 8F, a first and/or a second outer socket diameter 201, 202 of fixing sockets 14 is smaller than the discharge diameter of discharge holes 31. Of course, an embodiment of fixing socket 14 is also possible where an outer socket diameter 20 of fixing socket 14 is larger than the discharge diameter of discharge holes 31, such that fixing socket 14 is hammered or pressed into discharge hole 31.

It is self-evident that the characteristics of the especially preferred embodiments of the centrifuge drum described above as examples can also be combined in advantageous ways, depending on requirements and can in principle be applied to all known types of centrifuges. In particular, a centrifuge drum according to the invention can be used advantageously in a vertically or horizontally oriented centrifuge, in a continuously or discontinuously operating centrifuge, especially in a peeler centrifuge, a sliding discharge centrifuge, a one-stage or multi-stage pusher centrifuge, a double pusher centrifuge or in an oscillating centrifuge.

1. A centrifuge drum for a centrifuge for dividing a mixture into a solid material cake and a liquid phase, comprising:
a drum lid, a drum base and a drum jacket forming the centrifuge drum, the drum jacket extending along a longitudinal axis of the centrifuge drum, and at the drum jacket a number of discharge holes being arranged in radial direction to the longitudinal axis with a discharge diameter, and the drum lid and the drum base being arranged perpendicularly to the longitudinal axis diametrically opposite the drum jacket, and the drum lid, the drum base and the drum jacket together enclosing an inner space of the centrifuge drum, the centrifuge drum, in the installed state, being rotatable in the centrifuge around the longitudinal axis, and in the operating state being rotatable around the longitudinal axis by a drive with a predeterminable rotational speed, and a filter medium is disposed at an inner peripheral surface of the drum jacket, the filter medium being fixed by at least one fixing arrangement to the inner peripheral surface of the drum jacket, the fixing arrangement comprising a fixing socket extending along a socket axis, with a fixing collar, and the fixing socket being arranged from the inner space of the centrifuge drum in one of the discharge holes such that the filter medium is fixed by the fixing collar to the inner peripheral surface of drum jacket in radial direction to longitudinal axis.

2. The centrifuge drum according to claim 1, wherein the filter medium is at least one of a filter cloth and a support fabric.

3. The centrifuge drum according to claim 1, wherein a first outer socket diameter of the fixing socket is larger than a drainage diameter of the discharge holes.

4. The centrifuge drum according claim 1, wherein at least one of a first outer socket diameter and a second outer socket diameter of the fixing socket is smaller than a discharge diameter of the discharge holes.

5. The centrifuge drum according claim 1, wherein the fixing socket has a length, and a socket hole is disposed over at least some the length of the fixing socket along the socket axis.

6. The centrifuge drum according to claim 5, wherein the fixing socket includes a socket groove transverse to the socket hole.

7. The centrifuge drum according to claim 6, wherein the socket groove is aligned parallel to the longitudinal axis of the centrifuge drum.

8. The centrifuge drum according claim 5, where the fixing arrangement further includes a clamping bolt, the clamping bolt being arranged in the socket hole.

9. The centrifuge drum according to claim 8, wherein the clamping bolt is a fixing screw and the socket hole includes a socket thread via which the fixing screw is screwed to the fixing socket.

10. The centrifuge drum according to claim 4, wherein one of the discharge holes includes at least one locking element, the locking element, in a radial direction to the socket axis, has a flexibly deflectable partial section, and that the fixing socket has a recess at an outer peripheral surface, in operating position, the flexibly deflectable partial section extending into the recess of the fixing socket and securing the fixing socket in direction of the socket axis.

11. The centrifuge drum according claim 1, wherein the fixing collar has a round shape.

12. The centrifuge drum according claim 1, wherein the fixing collar is an n-gon.

13. The centrifuge drum according to claim 1, wherein the filter medium is at least one of a filter cloth and a support fabric.

14. A centrifuge, comprising a centrifuge drum according to claim 1.

15. A fixing arrangement comprising a fixing socket with a fixing collar configured to fix a filter medium to an inner peripheral surface of a drum jacket of a centrifuge drum according to claim 1.

16. The centrifuge drum according to claim 5, wherein the socket hole is a socket passage hole.

17. The centrifuge drum according to claim 10, wherein the recess is a circumferential recess.

18. The centrifuge drum according to claim 1, wherein the filter medium is at least one of a textile filter cloth, a textile support fabric, a plastic filter cloth, a plastic support fabric, a polypropylene filter cloth, a polypropylene support fabric, a metal filter cloth, a metal support fabric, a composite material filter cloth, a composite material support fabric, a carbon composite filter cloth, and a carbon composite support fabric.

19. The centrifuge according to claim 14, wherein the centrifuge is at least one of a vertically oriented centrifuge, a horizontally oriented centrifuge, a continually operating centrifuge, a discontinually operating centrifuge, a peeler centrifuge, sliding discharge centrifuge, a one-stage pusher centrifuge, a multi-stage pusher centrifuge, a double pusher centrifuge and an oscillating centrifuge.
